(19) United States
(12) Patent Application Publication
(10) Pub. No.: US 2011/0009059 A1
(43) Pub. Date: Jan. 13, 2011

(54) EXTENDED NETWORK COMMUNICATION SYSTEM

(75) Inventors: William O. Camp, JR., Chapel Hill, NC (US); Jacobus Cornelis Haartsen, Hardenberg (NL)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: Sony Ericsson Mobile Communications AB, Lund (SE)

(21) Appl. No.: 12/616,854

(22) Filed: Nov. 12, 2009

Related U.S. Application Data
(63) Continuation-in-part of application No. 12/501,053, filed on Jul. 10, 2009.

(51) Int. Cl. H04B 7/00; H04B 7/24

(52) U.S. Cl. 455/41.2; 455/39

(57) ABSTRACT

A radio system includes a server connected to a network, at least one bi-directional radio connected to the network and at least one uni-directional radio not connected to the at least one bi-directional radio and not connected to the server. A mobile device is configured to receive data from at least one uni-directional radio and communicate with at least one bi-directional radio.

### CROSS REFERENCE TO RELATED APPLICATIONS

This application claims benefit of priority as a continuation-in-part to the filing date of U.S. patent application Ser. No. 12/501,053, as filed on Jul. 10, 2009, which is incorporated herein by reference in its entirety.

### BACKGROUND

Currently, short-range radio communication systems (e.g. WLAN 802.11, Bluetooth, ZigBee, Z-Wave, etc.) use a bi-directional data exchange. These systems are based on connections that are controlled by higher-layer applications. Other short-range radio systems are based on uni-directional data transfer, where signals are only broadcasted and no connections are established.

For uni-directional systems, the receiver consumes a high level of power to detect a signal from a transmitter. The transmitter is either activated very infrequently (e.g., a few times a day for a wake-up radio) or is connected to the main supply (e.g., for indoor positioning). As such, the receiver in these systems must operate almost continuously (“always on”) in order to provide short latencies. These systems also require high frequency oscillators which consume a high amount of power.

Current short-range radio receivers result in high power consumption, in the order of 10 mW to 100 mW. In addition, current short-range radio receivers provide uni-directional radio system designs that are influenced by radio interference and RF frequencies.

### SUMMARY OF THE INVENTION

In accordance with an embodiment of the present invention, a radio system includes a server connected to a network, at least one bi-directional radio connected to the network and at least one uni-directional radio not connected to the at least one bi-directional radio and not connected to the server. A mobile device is configured to receive data from at least one uni-directional radio and communicate with at least one bi-directional radio.

In accordance with another embodiment of the present invention, a radio system includes a server connected to a network, a bi-directional radio connected to the server, and a uni-directional radio connected to the server. A mobile device is configured to receive data from one of the at least one uni-directional radio and communicate with at least one bi-directional radio.

In accordance with another embodiment, a mobile device includes a receiver configured to receive data from a bi-directional radio connected to the server and a uni-directional radio. The bi-directional radio is connected to a server via a network. The mobile device further includes a transmitter configured to communicate with the bi-directional radio.

Other aspects and features of the present invention, as defined solely by the claims, will become apparent to those ordinarily skilled in the art upon review of the following non-limiting detailed description of the invention in conjunction with the accompanying figures.

### BRIEF DESCRIPTION OF THE DRAWINGS

FIG. 1A is a system of exemplary devices having a transmit reference transmitter and other devices having a transmit reference receiver in accordance with one embodiment of the present invention.

FIG. 1B is a block diagram of a transmit reference transmitter in accordance with one embodiment of the present invention.

FIG. 2A is a block diagram of a transmit reference receiver in accordance with one embodiment of the present invention.

FIG. 2B is a block diagram view of a transmit reference receiver in accordance with another embodiment of the present invention.

FIG. 3 is a block diagram of a transmit reference transmitter capable of transmitting a signal with multiple channels in accordance with an embodiment of the present invention.

FIG. 4 is a block diagram of a transmit reference receiver capable of de-spreading a signal having multiple channels in accordance with an embodiment of the present invention.

FIG. 5 is a block diagram of a transmit reference receiver in accordance with another embodiment of the present invention.

FIG. 6 is a block diagram of a low power TRSS-DSSS hybrid system in accordance with an embodiment of the present invention.

FIG. 7 is a block diagram of a transmitter for an access point of a low power TRSS-DSSS hybrid system in accordance with an embodiment of the present invention.

FIG. 8 is a block diagram of a receiver of a mobile device for a low power TRSS-DSSS hybrid system in accordance with an embodiment of the present invention.

FIG. 9 is a block diagram of a low power TRSS-DSSS hybrid system in accordance with an embodiment of the present invention.

FIG. 10 is a block diagram of an extended network system in accordance with an embodiment of the present invention.

FIG. 11 is a block diagram of an extended network system in accordance with another embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

Embodiments of the present invention may take the form of an entirely hardware embodiment that may be generally be referred to herein as a “module”, “device” or “system.”

Embodiments of the present invention are described below with reference to illustrations and/or flowchart of methods, apparatus (systems) and computer program products according to embodiments of the invention. It will be understood that each block of the flowchart illustrations and combinations of blocks in the flowchart illustrations, can be implemented by firmware, computer program instructions, or a combination thereof. Any computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Low Power TRSS System

As described in more depth herein, embodiments of the present invention relate to a Transmit Reference Spread Spectrum (TRSS) system which applies a frequency offset to separate the reference signal from the information signal. In contrast to conventional Direct Sequence Spread Spectrum (DSSS) systems where the spreading reference needs to be recreated in the receiver, in the TRSS system, the reference is embedded in the transmitted signal. Because the transmit signal contains the information and reference signals, acquisition and synchronization as required in DSSS systems are not necessary, and thus, the signal can be de-spread instantaneously irrespective of the processing gain. In conventional DSSS systems, a lengthy acquisition time is needed to synchronize the locally generated reference signal with the received signal, which also requires a larger processing gain. Moreover, in the TRSS system, the reference signal does not have to be extracted from the received signal, but de-spreading can be achieved directly by a mixing procedure as is later described. Finally, since the reference does not have to be recreated or extracted, the reference can be anything, including wideband noise. In these respects it is quite different from a pilot signal which could be embedded in a DSSS system.

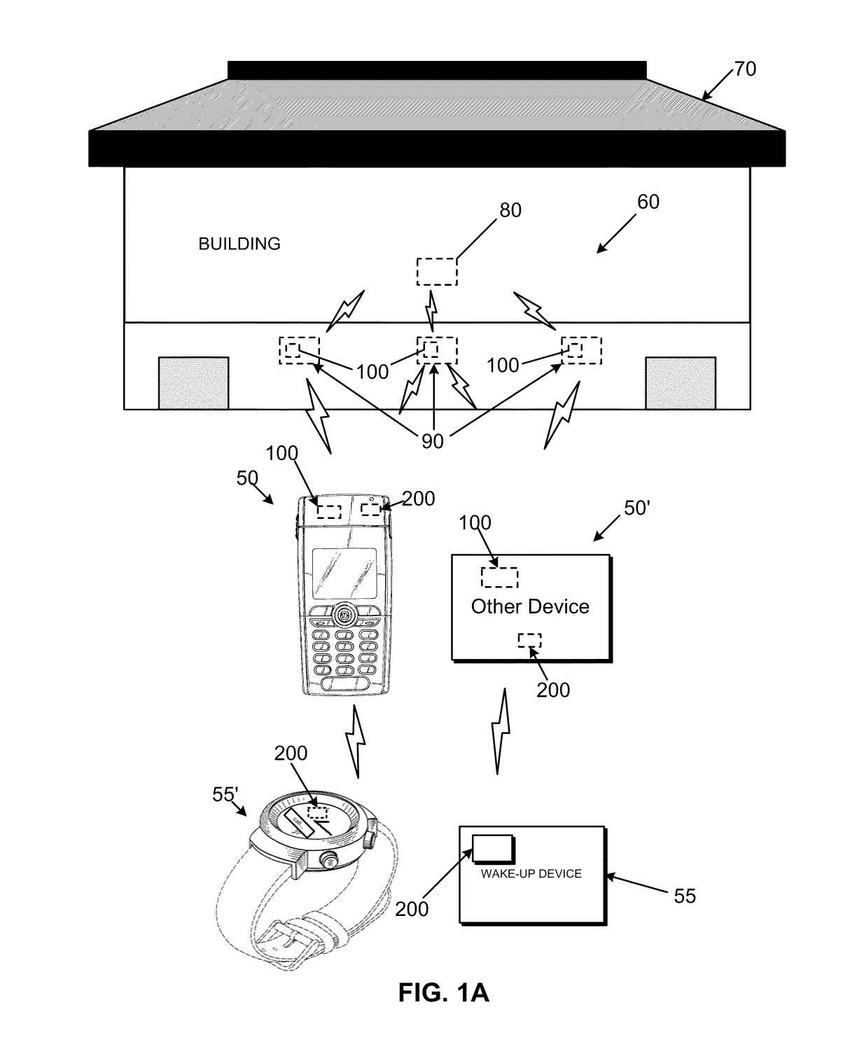

The following Figures illustrate exemplary embodiments of TRSS systems, TRSS transmitters and TRSS receivers. FIG. 1A is a system of exemplary devices having a transmit reference transmitter and other devices having a transmit reference receiver in accordance with one embodiment of the present invention. A TRSS transmitter and/or receiver, in some embodiments of the present invention, may be incorporated into any mobile device 50. Examples of such mobile devices 50 may include a cellular telephone 50, a watch 55′, a personal digital assistant (PDA), a cordless telephone, any portable computing device, a Bluetooth device, a laptop, any other electronic device 50′, and/or any other device. The phone 50 could include a TRSS receiver 200 so that it could be receiving TRSS signals from an indoor positioning system 60 or other system. Typically, very low power devices like the watch 55′ would only incorporate a TRSS receiver 200.

TRSS systems according to embodiments of the present invention may be used in uni-directional radio systems, including uni-directional short-range radio systems. One example of a uni-directional short-range radio system is a wake-up radio system 55. A wake-up radio system includes a wake-up receiver 200 and a transmitter 100 communicable together via a wireless message. At reception of this message by the wake-up receiver 200, which is transmitted by the transmitter 100, the wake-up receiver 200 will activate its host or other electronics associated with the wake-up receiver 200. For example, referring back to FIG. 1A, an exemplary wake-up receiver is illustrated as embedded in a watch 55′ or other wake up device 55. The cell phone 50 would be able to wake up the watch 55′ or other wake-up device 55 using its TRSS transmitter 100. For each device to be woken up, a specific wake-up message is used which has a bit sequence unique for the unit to be woken up. Specifically, the watch 55′ would receive a transmit signal (discussed later) sent from the transmitter 100 of the cell phone 50 when an incoming call or other alert occurs. Upon receipt of such transmit signal, the receiver 200 of the watch 55′ would activate (i.e., wake-up) at least a portion of the watch 55′ so that the watch 55′ could perform one or more actions, such as retrieve data from the transmit message, request data from the phone 50, display that a call is incoming, display that a message (e.g., email message, MMS message, SMS message, etc.) has arrived, alert the user that a reminder has occurred, or perform other activities associated with other triggering events. All of this would occur based on a low power radio system (e.g., low power wake-up system). Because the low-power feature of this system, the wake-up radio system 55 may be ideal for battery operated devices, such as a watch 55′ or other device.

Another example of a uni-directional short-range radio system is an indoor positioning estimation system 60 where one or more beacons 90 are spread out in a building 70 and broadcast positioning transmit messages to a recipient, which may be the cell phone 50, other mobile devices 50′, a controller 80, or any other type of processing device. The beacons 90 may include a transmitter 100 of the present invention. The recipient (e.g., cell phone 50′) receives the positioning messages via a receiver 200 of the present invention that may be embedded in the recipient. Based on these positioning messages, the recipient can determine the transmitter's location inside the building 70. For example, after receipt of the beacon signal, the recipient may retrieve information from the transmitted signal which indicates the beacon position (e.g., maps of the building, location of beacons, closest beacon position, etc.) or any other data desired to be transmitted to the recipient. In one embodiment, the beacon 90 may optionally, include a receiver of the present invention (not shown) so that the recipient can transmit a reply message to one or more beacons 90 upon recipient of the broadcast of the positioning messages or other messages from the beacons 90.

Other applications are also realized with the present invention and the wake-up system 55 and indoor positioning systems 60 are only meant to be two exemplary applications of the present invention.

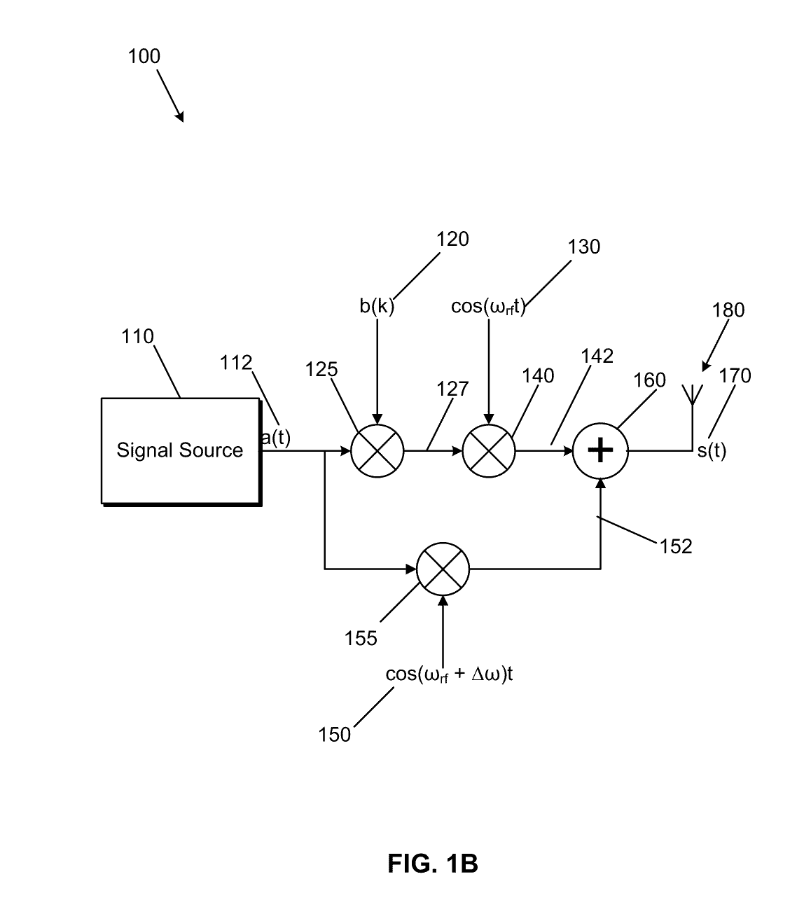

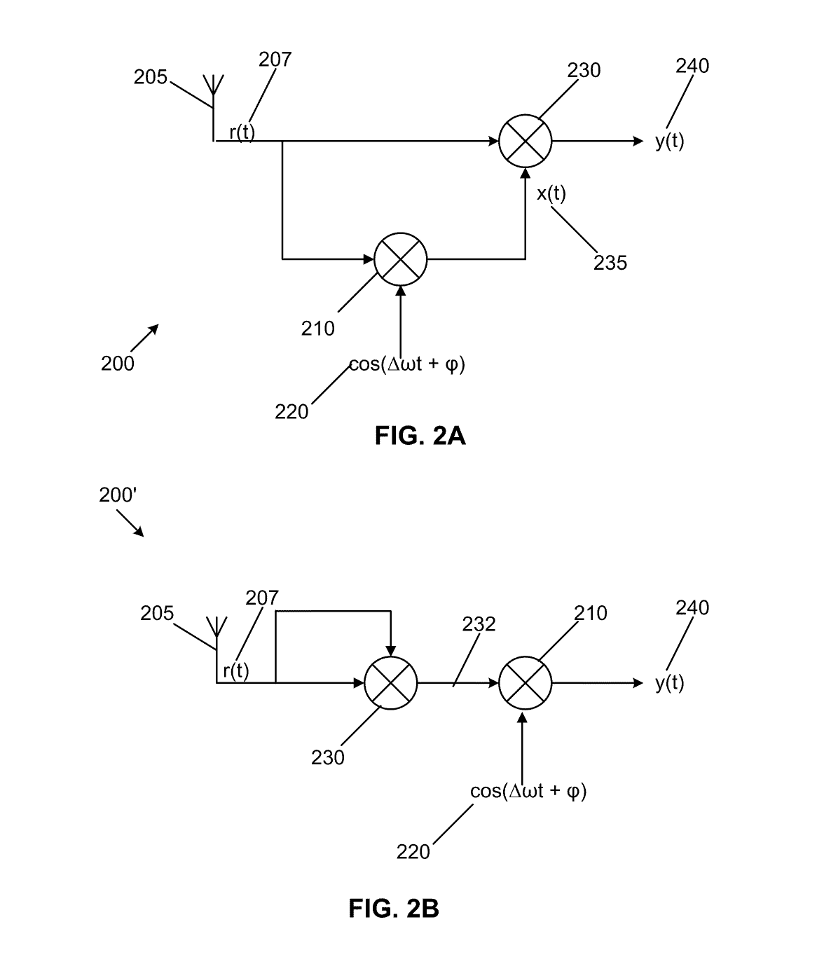

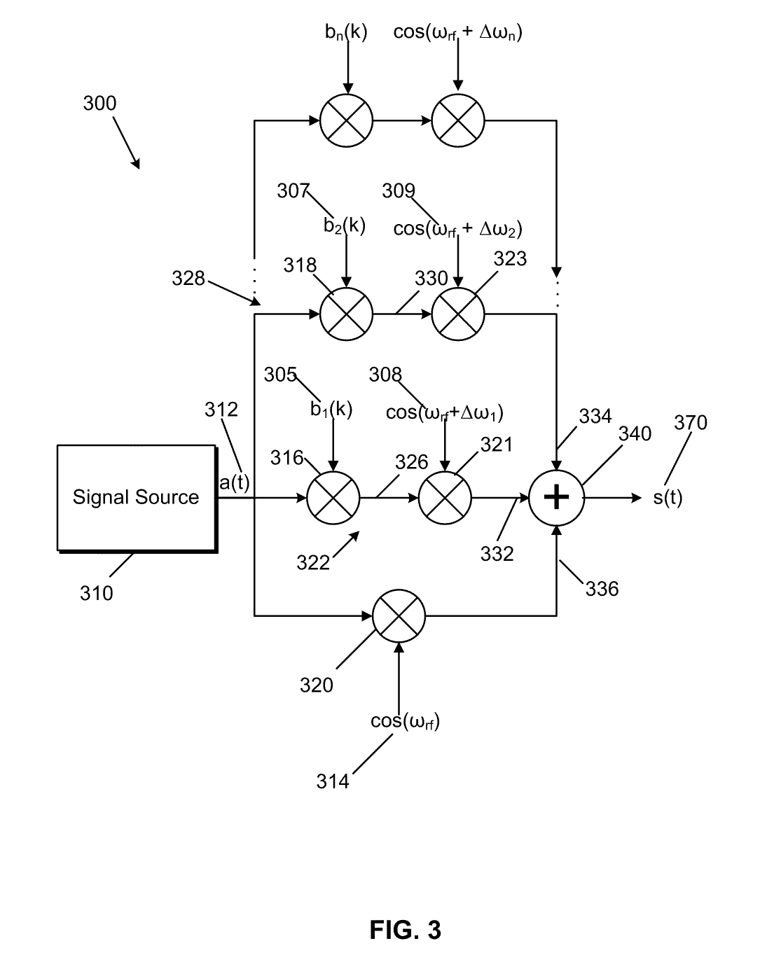

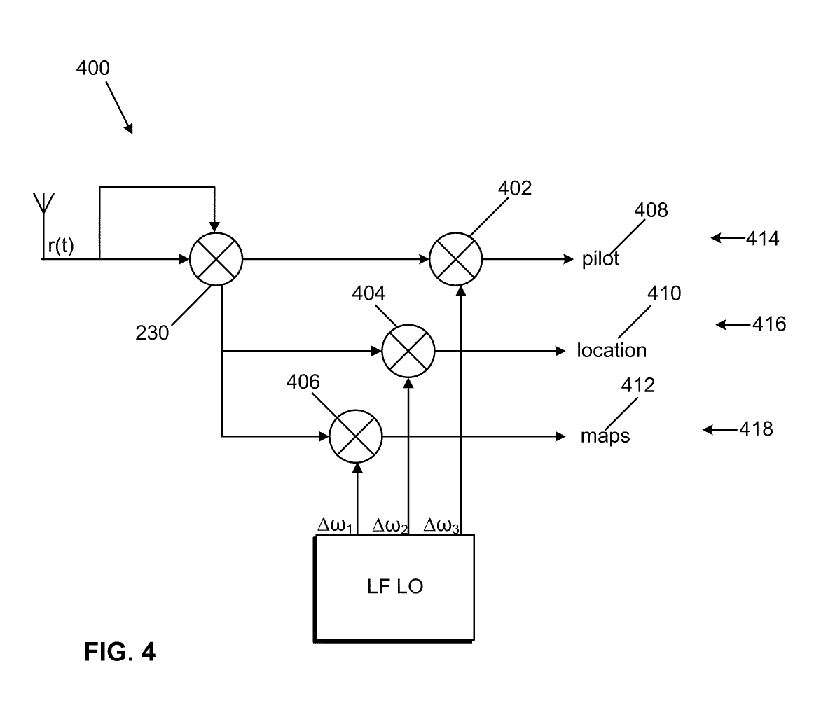

It should be noted that the transmitter and receivers presented in FIG. 1A may employ any transmitter or receiver in accordance with any embodiment of the present invention, including the embodiments 200, 300, 400, 500 illustrated in FIGS. 2-5 or any other embodiments of the present invention. For example, the transmitter presented in the mobile devices 55 and 55′ may be the transmitter 300 as illustrated in the exemplary embodiment of FIG. 3 and the receiver illustrated in FIG. 1A may be the receiver 400, 500 presented in the embodiments shown in FIG. 4 or 5.

FIG. 1B is a block diagram view of a TRSS transmitter 100 in accordance with one exemplary embodiment of the present invention. The transmitter 100 includes a signal source 110 to generate a wideband reference signal, a(t), 112. The reference signal 112 may be any signal suitable for modulation by another signal. The reference signal 112 may be generated at any frequency, such as a specific radio frequency (RF), and can be generated using any electronics, such as a RF voltage controller oscillator (VCO) with reasonable accuracy. It should be understood that the reference signal 112 can be generated using any other electronics as the present invention is not limited to the reference signal generated by a RF VCO.

In one embodiment, the reference signal can be generated at baseband or intermediate frequency (IF) and then be up-converted to RF or other desired frequency. The bandwidth (e.g. RF band) of the reference signal 112 can be any desired bandwidth. In one embodiment, the reference signal 112 can be any RF band, such as any industrial, scientific and medical (ISM) band (e.g., 2.45 GHz). In another embodiment, the reference signal 112 can be any lower band, such as the FM band from 88 to 101 MHz. It should be understood that the reference signal 112 can be any band of frequencies and the present invention is not limited to only an RF band or FM band.

The reference signal 112 is modulated by the information-bearing data signal, b(k), 120, at multiplier 125, resulting in a first modulated signal 127. This data signal b(k) can use any modulation scheme, such as BPSK, QPSK, 16-QAM, etc. The modulated signal 127 is then multiplied with signal 130 (e.g., cos (ω_{rf}t)) by multiplier 140 where ω_{rf} is the RF carrier frequency. Additionally, a frequency offset signal 152 (e.g., a(t)*cos(ω_{rf}+Δω)t) is created by multiplying signal 150 (e.g., cos(ω_{rf}+Δω)t) with reference signal a(t) 112 by multiplier 155, where Δω is the transmitted offset frequency. This resulting signal 152 is then is combined with a signal 142 (e.g., a(t)*b(k)*cos(ω_{rf}t)) by adder 160, resulting in a transmit signal s(t) 170. The transmit signal 170 is represented by:

s(t)=b(k)·a(t)·cos(ω_{rf}t)+a(t)·cos(ω_{rf}+Δω)t

where ω_{rf} is the RF carrier frequency and Δω is the offset frequency. Typically, the RF frequency ω_{rf} is in the order of 100 MHz to a few GHz, whereas the offset frequency Δω is in the order of a few kHz or MHz.

It is noted that the bandwidth BWₐ of the reference signal 112 is much broader than the bandwidth BW_{b} of the information-bearing data signal 120 so that a spectrum spreading results. In one exemplary embodiment, the reference bandwidth BWₐ is some tens of MHz. Since the offset frequency is much smaller (e.g., in the order of 1 MHz or less), the spectra of the reference signal 112 and combined data-reference signal almost completely overlap.

After the transmit signal s(t) 170 is generated, the transmit signal s(t) 170 may then be transmitted through an antenna 180 into surrounding space, which, in turn, may be received by a receiver 200, which is discussed below with regards to FIG. 2.

FIGS. 2A-2B illustrate block diagrams of exemplary transmit reference receivers 200, 200′ in accordance with some embodiments of the present invention. The receiver 200, 200′ includes an antenna 205, which receives the transmit signal s(t) 170 from the transmitter 100 after s(t) has traveled a certain distance.

Compared with the transmit signal s(t), the received signal r(t) at the receive antenna 205 will likely be attenuated because of the radio propagation. Furthermore, the transmit signal may be distorted due to multipath phenomena encountered on the radio propagation path. The received signal (or “received transmitted signal”), as referred to herein, relates to the propagated transmit signal, which may have been distorted.

In the receiver 200, 200′, the received signal (r(t)) 207 proceeds to at least two multipliers, 210 and 230, for de-spreading and, optionally, demodulation. The exact location and configuration of these multipliers can be variable. For example, FIG. 2A illustrates one configuration of the receiver 200: at multiplier 210, the received transmit signal r(t) 207 is multiplied by frequency offset signal 220 (e.g., cos(Δωt+φ)) resulting in a frequency-shifted signal (x(t)) 235. This frequency-shifted signal x(t) 235 is represented by:

$$\begin{matrix}x ( t ) = r ( t ) \cdot cos ( Δω t + ϕ ) \\ = \{ b ( k ) a ( t ) \cdot cos ( {ω}_{rt} t ) + a ( t ) \cdot cos ( {ω}_{rt} + Δω ) t \} cos ( Δω t + ϕ )\end{matrix}$$

The frequency-shifted signal x(t) 235 is multiplied with the received transmit signal r(t) 207 by multiplier 230 resulting in the de-spread signal (y(t)) 240. It should be noted that de-spread signal 240 (y(t)=r(t)² cos(Δωt+φ)) produced by the receiver 200 is a square of the received signal (r(t)²) multiplied by the frequency offset signal 220 (e.g., cos(Δωt+φ)).

FIG. 2B illustrates an alternate embodiment where the position of the multipliers 210, 230 may be different than that presented in FIG. 2A, but still result in the same de-spread signal 240 ((y(t)=r(t)² cos(Δωt+φ)). As illustrated, multiplier 230 may act as a squaring circuit first and then, the resulting signal 232 (r(t)²) is multiplied by signal 220 (e.g., cos(Δωt+φ)) by multiplier 210. Again, this de-spread signal 240 (y(t)=r(t)² cos(Δωt+φ)) is a square of the received signal (r(t)²) multiplied times the frequency offset signal 220 (e.g., cos(Δωt+φ)). Thus, the demodulated signal 240 is the same whether the receiver of FIG. 2A or 2B is used.

It should be further noted that the RF frequency (ω_{rf} ) does not occur in the receiver circuit, but instead, only the offset frequency (Δω). As such, there is no high-power RF local oscillator (LO) included or required in the receiver. Furthermore, the reference signal a(t) does not need to be regenerated in the receiver 200, 200′ for de-spreading or demodulation of the received signal 207.

If only squaring is applied, the desired de-spread information-bearing signal 120 will be located at the offset frequency Δω and this signal can be retrieved at IF. This may be advantageous since greater gains at IF can be obtained. In addition, the unknown or variable phase φ does not need to be retrieved. In this case, demodulation takes place from 232 and the mixer 210 in 200′ FIG. 2B is skipped.

The receiver 200′ squares the received signal r(t) 207. After squaring, the resulting signal 232 is calculated as follows:

$$\begin{matrix}y ( t ) = {[ b ( k ) \cdot a ( t ) \cdot cos ( {ω}_{rf} t ) + a ( t ) \cdot cos ( {ω}_{rf} + Δω ) t ]}^{2} \\ = {b}^{2} ( k ) {a}^{2} ( t ) {cos}^{2} ( {ω}_{rf} t ) + {a}^{2} ( t ) {cos}^{2} ( {ω}_{rf} t + Δω t ) + 2 b ( k ) {a}^{2} ( t ) \\ \{ \frac{1}{2} cos ( Δω t ) + \frac{1}{2} cos ( 2 {ω}_{rf} t + Δω t ) \} \\ = \frac{1}{2} {b}^{2} ( k ) {a}^{2} ( t ) \{ 1 - cos ( 2 {ω}_{rf} t ) \} + \\ \frac{1}{2} {a}^{2} ( t ) \{ 1 - cos ( 2 {ω}_{rf} t + 2 Δω t ) \} + b ( k ) {a}^{2} ( t ) \\ \{ cos ( Δω t ) + cos ( 2 {ω}_{rf} t + Δω t ) \}\end{matrix}$$

As shown in the equation above, the resulting DC component at the carrier frequency is:

$$\frac{1}{2} \{ {b}^{2} ( k ) \cdot {a}^{2} ( t ) + {a}^{2} ( t ) \}$$

and the component at the offset frequency (Δω) is b(k)·a²(t). Note that the signal component at the offset frequency (IF) is the information bearing signal including b(k). The signal at DC can be considered a self-interference signal. The components that are located at twice the RF carrier frequency (˜2ω_{rf}) may be ignored and thus, can be filtered away (or integrated and dumped) using a filter or like device.

To prevent inter-carrier interference (e.g. from the self-interference signal located at DC), the spectrum of the squared reference a²(t) should resemble a Dirac impulse. To accomplish this, the reference signal 112 (a(t)) should produce a constant amplitude after squaring. This can be achieved by using a constant envelope function, e.g. a binary function. In one embodiment, if the reference signal 112 (a(t)) and the information-bearing signal 120 (b(k)) are binary signals (e.g., +1, −1), the resulting square will be a constant: a²=1, b²=1. In the frequency domain, the DC component

$$( \frac{1}{2} \{ {b}^{2} ( k ) \cdot {a}^{2} ( t ) + {a}^{2} ( t ) \} )$$

of the demodulated data signal 120 (b(k)) (i.e. after whereas the de-spread information-bearing signal 120 (b(k)) (i.e. after de-spreading in the receiver) arises at the offset frequency Δω. This information-bearing signal is thus extracted from the transmitted signal 170 without having to generate a reference signal or via the use of a high-frequency local oscillator. Nonetheless, since the squared reference signal at DC is a spike, there is no cross-interference between the information-bearing signal 120 and the reference signal 112. Subsequent mixing with the offset frequency Δω will move the intermediate frequency (IF) portion of the signal to baseband where the information-bearing signal 120 (b(k)) can be retrieved.

In one embodiment, the symbol rate of the de-spread information-bearing signal 120 b(k) and the frequency offsets Δωᵢ are based on 32 kHz (or other low frequency) which is also used for the real-time clock. The receiver then only needs a low power oscillator (LPO) with a 32 kHz reference from which all clocks in the receiver are derived. The low frequency of the oscillator allows for a low power oscillator to be employed and thus, the receiver becomes a low powered device. In one embodiment, the power of the low power oscillator allows for the peak power consumption of the receiver to be fully operated at 10-100 μW. Thus, applications, such as wake-up radios, do not need to be based on amplitude shift keying (ASK) or on-off keying, and can still apply spectrum spreading to obtain robustness in a multi-path fading and interference-prone environment.

FIGS. 1B, 2A and 2B illustrate a TRSS system with a single channel carrying a single information-bearing signal 120 in the transmit signal 170. However, it should be understood that multiple information-bearing channels can be embedded in the transmit signal 170 by applying multiple data branches each with their own offset frequency Δωᵢ. FIG. 3 illustrates a block diagram view of an exemplary multiple channel transmit reference transmitter in accordance with an embodiment of the present invention.

It is noted that, in FIG. 3, the offset signals cos(ω_{rf}+Δω₁) 308 and cos(ω_{rf}+Δω₂) 309 are applied to the information-bearing signals 305 and 307 (bᵢ(k)) rather than to the reference signal 312 (a(t)). It should be understood that the offset signals cos(ω_{rf}+Δω₁) 308 and cos(ω_{rf}+Δω₂) 309 may be applied to either the respective data signals b₁(k) 305, b₂(k) 307 or the reference signal a(t) 312.

In determining the transmit signal s(t) 370 for the multiple channel transmitter 300, a signal source 310 first generates the reference signal 312.

The reference signal 312 is then sent to multiple different multipliers 320, 316 and 318. At multiplier 320, the reference signal 312 is multiplied by the carrier frequency signal (ω_{rf} ) 314, resulting in a carrier reference signal 336. At a first channel branch 322, the reference signal 312 is multiplied by a first information-bearing signal (b₁(k)) 305 by a multiplier 316 and the resulting signal 326 is then multiplied by a first offset frequency signal (cos (ω_{rf}+Δω₁)) 308 by multiplier 321. At a second channel branch 328, the reference signal 312 is multiplied by a second information-bearing signal (b2(k)) 307 by multiplier 318 and the resulting signal 330 is then multiplied by a second offset frequency signal (cos (ω_{rf}+Δω₂)) 309 by multiplier 323. The modulation schemes for b₁(k) and b₂(k) may not necessarily be the same. For example, the modulation scheme for b₁(k) may be BPSK while the modulation schemes for b₂(k) may be QPSK. Nonetheless, the signals 332 and 334 resulting from each channel branch 322 and 328 are combined with the carrier reference signal 336 by adder 340 resulting in the transmit signal (s(t)) 370. The transmit signal (s(t)) 370 is thus:

s(t)=a(t)cos(ω_{rf}t)+b₁(k)+a(t)·cos(ω_{rf}+Δωₜ)t+b₂(k)·a(t)·cos(ω_{rf}+Δω₂)t

This transmit signal 370 is transmitted through an antenna of the transmitter 300 into space.

The optimal signal-to-noise ratio (SNR) is obtained when (Δω₁)=πn/T_{b} where T_{b} is the symbol period of the data signal b(k) and n an integer (e.g., n=1, 2 for 2 channels).

Because of the non-linear, squaring operation of the received signal r(t), self-interference will arise due to the inter-modulation mixing of different components of r(t). To avoid inter-modulation products to end up in viable channels, combinations of additions and/or subtractions of the offset frequencies should not be equal to any of the offset frequencies themselves (i.e., Δωᵢ±Δωⱼ≠Δωₖ where i, j, k=1, 2, 3, . . . n for n parallel channels). This can, for example, be realized by selecting odd harmonics (e.g., 1 MHz, 3 MHz, 5 MHz . . . 2 m+1 MHz) for the offset frequencies for the channels. After squaring, the inter-modulation products due to self-interference will then end up at even harmonics (e.g., 0 MHz, 2 MHz, 4 MHz, 6 MHz, . . . 2 m MHz) which are not on any of the viable channels. Other combinations are possible that equally prevent inter-modulation.

As an example, a TRSS system operating in the FM broadcast spectrum (88-101 MHz) could have a RF center frequency of ω_{rf}=98 MHz and a spreading bandwidth (BW) of 16 MHz. Assuming an information rate (R) of R=32 kb/s (based on the typical frequency of 32 kHz of a Real-Time clock), the offset frequencies could be chosen to be Δω₁=5 R=160 kHz, Δω₂=8 R=256 kHz, and Δω₃=11 R=352 kHz. Inter-modulation products due to self-interference as the square thereof will arrive at f=3 R=96 kHz, f=6 R=192 kHz, and f=10 R=320 kHz, each of which is adjacent to the desired signals. Furthermore, inter-modulation products caused by strong FM broadcast signals may arrive at f=200 kHz, f=300 kHz, f=400 kHz, and so on. The latter is based on the fact that the FM channel spacing is 100 kHz with at least a minimum separation of 200 kHz between adjacent FM channels. Also these inter-modulation products will be outside the bands of interest.

As another example, a TRSS system operating in the 2.4 GHz ISM spectrum could have a RF center frequency of ω_{rf}=2441 MHz and a spreading bandwidth of 80 MHz. Assuming the same information rate of R=32 kb/s, the same offset frequencies can be selected, as indicated in the above example. All radio standards operating in the 2.4 GHz ISM band have a channel grid and spacing of at least 1 MHz. The first inter-modulation product after squaring will be at 1 MHz which is well above the offset frequencies presented.

For a wake-up system or other systems, a single channel may suffice. The channel will send a specific bit sequence that will wake-up the receiver. Only if this specific bit sequence is received will the receiver wake-up its host. A pilot channel could be added to support the synchronization in the receiver. Note that this pilot will be generated at baseband and follows the same modulation and combination with offset carriers as the information-bearing signals. Preferably, the data stream bₚ(k) for the pilot uses a very simple modulation scheme like BPSK.

In one embodiment, the pilot channel is self-decoding. The pilot is obtained using the correct offset frequency between the reference and the pilot channel. As such, the pilot is obtained immediately and with minimal power. For example, to obtain the pilot, there is no need for a local oscillator at the RF frequency and the pilot does not need to be generated in the receiver.

In an indoor positioning system or other systems, multiple of channels could be added that provide different kinds of data. For example, we could have one pilot channel at Δω₁ which indicates that a beacon is present; a second channel at Δω₂ may carry positioning information; a third channel at Δω₃ may provide local maps that can be downloaded; and Δωₙ providing other information; and so on. A receiver for receiving multiple channels is shown in FIG. 4.

FIG. 4 is a block diagram view of a multiple channel transmit reference receiver 400 in accordance with an embodiment of the present invention. As illustrated in the exemplary embodiment, three mixers 402, 404, and 406 provide the signal for pilot data 408, location data 410, and map data 412, respectively, each of which are on different channels 414, 416, 418.

One exemplary embodiment, however, may only contain a single mixer that can be tuned to each of the different offset frequencies Δω₁, Δω₂ and Δω₃ For example, first, the receiver would tune to Δω₁ to look for a pilot signal. Once found, the pilot signal can give important information for fine synchronization and timing. Then, the receiver would tune to the second offset frequency Δω₂ to retrieve its position signal. Only in case the proper maps are not already in the host may the receiver tune to Δω₃ a to download one or more maps. Although three channels 414, 416, 418 are illustrated in FIG. 4, any amount of channels may be employed in the transmitter 300 and receiver 400 as the present invention is not limited to any specific number of channels.

The pilot signal 408 may carry a simple one-zero sequence. This sequence should be easy to detect and can be a presence indication of an indoor beacon or a wake-up signal. The pilot 408 can also provide symbol and/or frame timing information to the receiver 400. Once found, this information can then be used by the receiver 400 to demodulate one or more channels 416, 418.

Further, the pilot signal 408 can be used to obtain the proper phase and frequency of the offset frequency Δω at the receiver 400. At the transmitter 300, an offset carrier of cos(Δωt) is applied. In the receiver 400, a signal cos((Δω+δ)t+φ) can be recreated and for proper demodulation, δ=0 and φ=0. We could obtain this by applying an IQ mixer (i.e., multiplying the signal with cos((Δω+δ)t+φ) and sin((Δω+δ)t+φ) and perform frequency and phase tracking in the digital domain to compensate for δ and φ.

FIG. 5 is a block diagram view of a transmit reference receiver 500 in accordance with yet another exemplary embodiment of the present invention. This receiver 500 is another lower power solution that embeds the cos(Δωt) information 502 in the pilot signal p(k) 504. To accomplish this, the one-zero pattern in the pilot 504 is phase and frequency synchronized to cos(Δωt) when created in the transmitter (not shown). The receiver 500 can lock to the pilot signal 504 (which may be AM modulated if δ≠0) to retrieve a sync signal 506 that can control the low power local oscillator (LF LO) at the receiver 500. The pilot channel of receiver 500 at offset frequency Δω₁ carries the one-zero pattern p(k) 504. This one-zero pattern is phase and frequency synchronized to cos(Δω₁) 502 in the transmitter. Since Δω₁, Δω₂, and Δω₃ are integer multiples of each other, the pilot 504 may also provide the sync signal 506 for the other channels. At the transmitter, the information-bearing signal and pilot channel 504 can be assigned different power levels. For the pilot signal 504, the SNR does not have to be very high since it only needs to lock a LF LO in a phase lock loop (PLL) configuration that creates the offset frequencies.

In addition to the phase and frequency synchronization, the pilot signal 504 can also provide a reference for the symbol timing and the frame timing on the other channels. The rising and falling edges of the zero-one pattern can be used for bit timing purposes. For frame timing, the one-zero sequences, whose length corresponds to the frame length, can be inverted and alternated. For example, for a frame length corresponding to 6 pilot symbols (note that a pilot symbol may be longer than the data symbols on the other channels; the pilot rate may be 32 kb/s whereas the data rate may be 320 kb/s) two sequences would be needed: 101010 and 010101. By alternating the sequences, we obtain a frame sync at the boundary of two sequence: 101010, 010101, 101010, etc. Alternatively, the frame sync may be embedded on the information-bearing channels itself, i.e. a specific bit pattern on the information-bearing channel may indicate the start of a frame. In another embodiment, the frame timing may be indicated by a simple duplication at the frame boundary of a 1 or 0 bit in the alternating 1-0 sequence of the pilot channel.

The circuit results in a very low-current receiver that can operate below 1 mW levels. By properly dimensioning the system (selection of binary data and reference signals, off harmonic frequency offsets, all based on 32 kHz), a high-performance, robust system results. Self-synchronization is achieved by including a one-zero pattern as pilot channel.

### Low Power TRSS-DSSS Hybrid System

Short-range radio communication systems use bi-directional data exchange based on connections that are established, released, and controlled by higher-layer applications. Further, as described above, a uni-directional radio may be used in broadcast mode to only broadcast information in one direction, such as from a fixed location to a mobile location.

As previously described with regard to the above section labeled “Low Power TRSS System,” the absolute frequency of the uni-directional radio system may be any frequency. Such uni-directional radio system may use a Transmit Reference (TR) scheme with a LF frequency offset between the information signal and the reference signal. Only this offset frequency, which is in the order of a few KHz to a few MHz, is recreated accurately in the receiver. The RF signal can be mapped directly to baseband by self-mixing. The low power TRSS-DSSS hybrid system described below combines the above low power TRSS system with a second DSSS bi-directional radio channel (or separate radio) to form a system that has both maximum channel performance and minimum power consumption. This low power TRSS-DSSS hybrid system will now be described.

It should be noted that the scope of the present disclosure should not be limited to a specific implementation of dfTRSS, but can be applied to any system.

Generally, according to some embodiments, the low power TRSS-DSSS hybrid system 600 includes a set of short-range radio systems that are based on a first radio channel using: (1) a first radio channel (i.e., a dfTRSS uni-directional radio) 601 that only transmits data uni-directionally; combined with (2) a second radio channel 602 using DSSS uni-directional or bi-directional data transfer. The second radio channel 602 can be either share hardware with the first radio channel 601 or the second radio channel 602 could be a completely separate DSSS radio. One feature of the low power TRSS-DSSS hybrid system 600 is that the time required to find and synchronize the second DSSS radio channel 602 is mitigated. This minimizes the time that the second DSSS radio channel 602 is on (or active/idle), reducing power consumption.

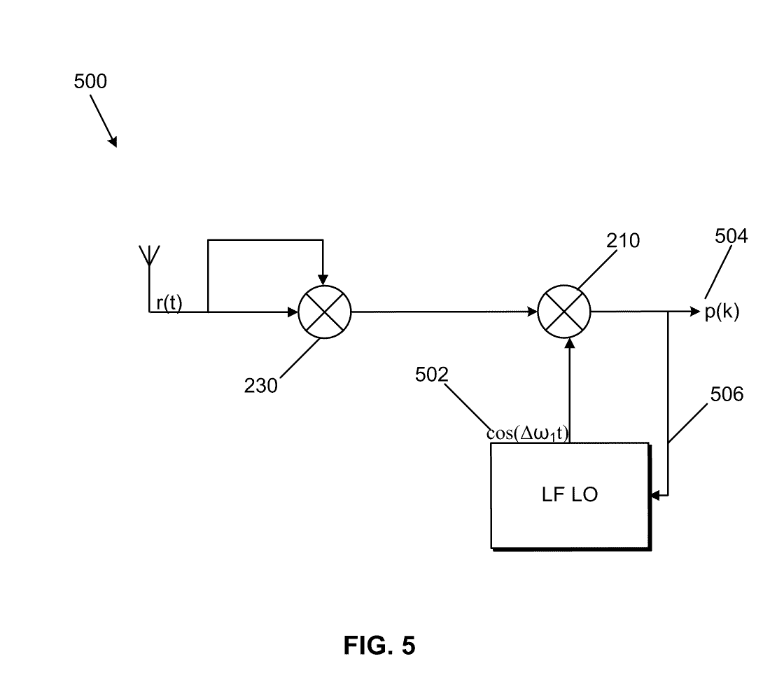

FIG. 6 illustrates an exemplary low power TRSS-DSSS hybrid system 600 in accordance with some embodiments. The TRSS-DSSS hybrid system 600 includes at least one access point 604, a mobile device or terminal 606, a local area network (LAN) 608 and a server 610. As previously discussed, the mobile device 606 can be any portable electronic communications device, such as a cellular telephone, a laptop or other type of computer, or any other type of device which can transmit and/or receive data wirelessly. The access point 604 can be a device that includes a low power dfTRSS wake-up, uni-directional radio channel 601 and one or more DSSS radio channels 602. In some embodiments, the access point 604 refers to a means for connecting the mobile device 606 to the server 610. The access point 606 may be located anywhere, such as being fixed at a location in a building or at any other geographic location (whether connected to a building or not).

Multiple channels can be supported by creating multiple radio channels. As shown in FIG. 6, the access point 604 includes combined, multiple radio channels 601, 602 (e.g., uni-directional and bi-directional radio channels). These radio channels 601, 602 share common hardware according to some embodiments.

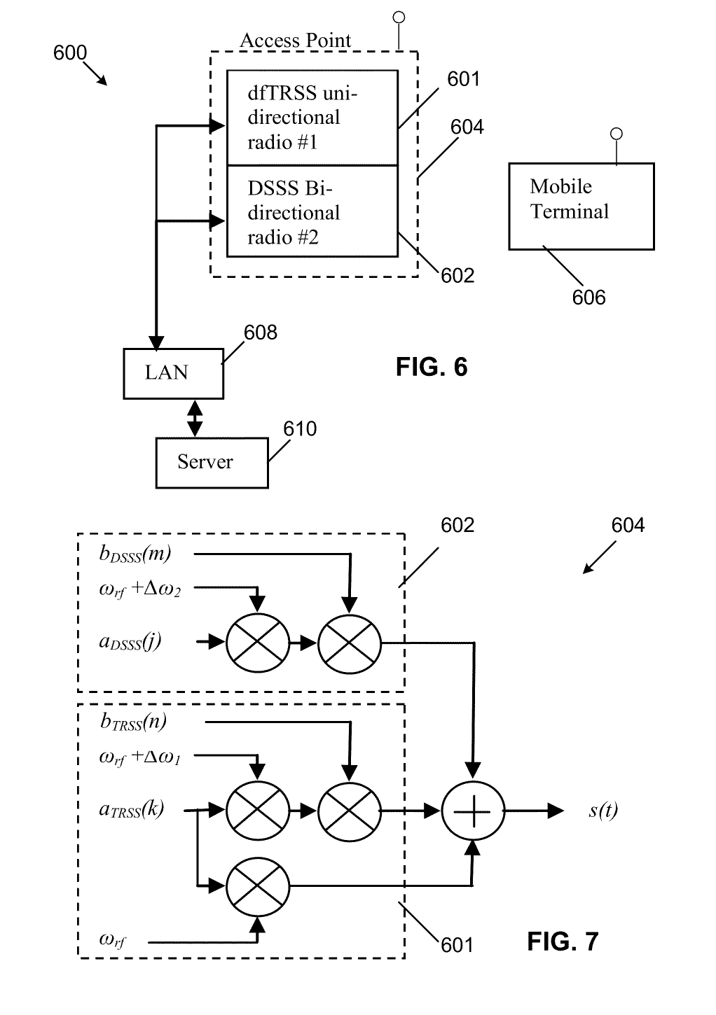

FIG. 7 illustrates exemplary logical functions for the transmitter of the access point 604 of FIG. 6. Two signal bearers (ω_{rf}) with an offset frequency Δω₁ make up the dfTRSS uni-directional transmitter. The spreading code for this dfTRSS uni-directional transmitter channel is a_{TRSS}(k) and the data is b_{TRSS}(n), where k cycles through its range (the spreading factor) once for every value n. A third channel uses a different spreading code a_{DSSS}(j), transmits data b_{DSSS}(m), where j cycles through its range (which can be a different spreading factor) once for every value of m, and constitutes the transmitter for the DSSS bi-directional transmitter. The offset frequency Δω₂ can be either different from Δω₁ or equal to Δω₁ or be zero.

As will be described in more depth later, the relationship between the alignment of the various signals is fixed in the transmitter in the access point and known to the receiver in the mobile device. Specifically, a known relationship between the signals b_{TRSS}(n) and a_{DSSS}(j) and between b_{TRSS}(n) and b_{DSSS}(m) exists. This relationship may involve more than a simple alignment of bit edges, as the rates of these three signals (i.e., a_{DSSS}(j), b_{TRSS}(n) and b_{DSSS}(m)) may not be close to each other. In the case of a DSSS radio that uses a “long code” pseudorandom (PRN) spreading sequence, the signal b_{TRSS}(n) has a unique feature embedded therein to align to the beginning of the a_{DSSS}(j) sequence, as the length of the complete sequence of a_{DSSS}(j) may be longer than the bit period of b_{TRSS}(n). Also, if the data rate of b_{DSSS}(m) is not an integer ratio of the data rate for b_{TRSS}(n), then a unique feature in b_{TRSS}(n) may be needed for synchronization as well. As such, the relationship between the carrier signals Δω₁ and ω_{RF}+Δω₂ may provide increased synchronization as well as other benefits.

It is noted that the receiver in the access point may be a standard DSSS configuration and is not specifically illustrated.

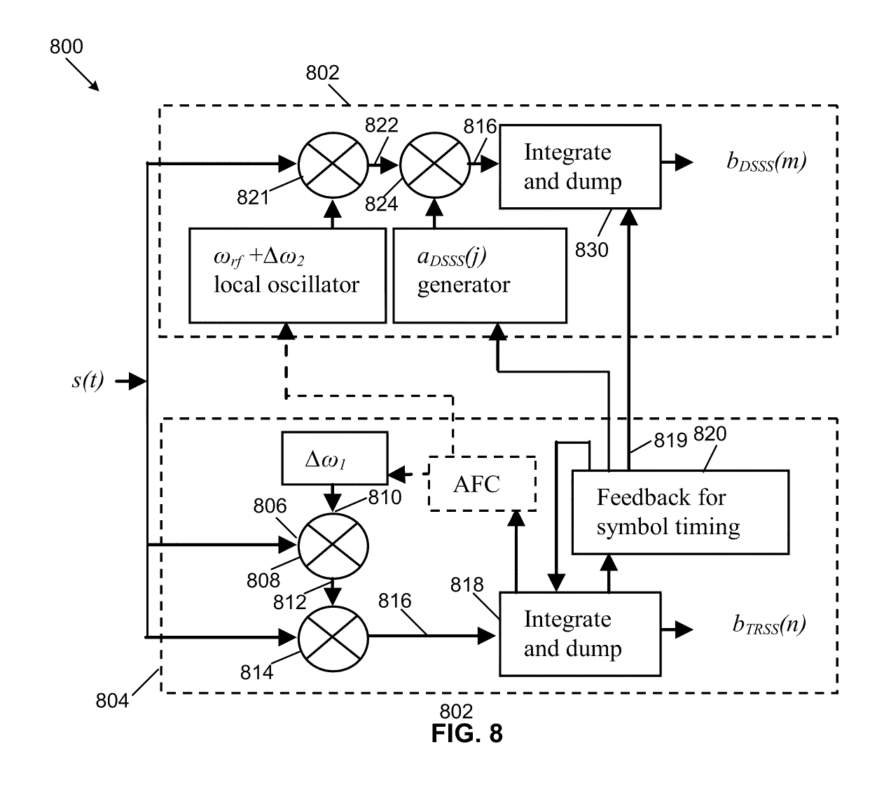

The receiver 800 in the mobile device 606 is shown in FIG. 8. As illustrated, the receiver 800 includes two radio receiver paths: (1) a path 804 for a receiver for a uni-directional radio dfTRSS receiver and (2) a path 802 that constitutes a receiver for the DSSS bi-directional radio. A signal, s(t), received from the antenna of the receivers in the first path 804 is transmitted to a port 806 of a first mixer 808. The first mixer 808 also receives a signal Δω₁ as an input to its other port 810. The output 812 from this mixer 808 and the original input signal s(t) are then transmitted to a second mixer 814. The output 816 from this second mixer 814 is then integrated via an “integrate and dump” circuit 818 (which may be equivalent to a lowpass filter) and is also sampled to create the data stream b_{TRSS}(n). In order for this process of integration and sampling to occur properly, the correct timing of the bit location may be extracted in a feedback loop 820, which is shown schematically in the box labeled “feedback for symbol timing.” The output 819 of the feedback loop 820 is used to correctly position the timing of the “integrate and dump” circuit 818 in the uni-directional dfTRSS receive path 804. It is noted that the sample timing also determines when to stop (i.e., “dump”) the integration and collect the output sample and set the integrator to zero to restart the integration of the signal from the mixer 816.

The second receiver path 802 also starts with the received input signal s(t), and a mixer 821 mixes that signal with a local generated signal at the same carrier frequency ω_{RF}+Δω₂ as that used to create the signal in the access point transmitter function (AFC). The resulting signal 822 is then mixed at mixer 824 with a replica of the spreading code, a_{DSSS}(j) that de-spreads the signal. This only happens if the time alignment of the replica of the spreading code is properly aligned in time with the received signal. This process to properly align the replica with the received signal, which also called a “synchronization process,” is greatly sped up in the inventive apparatus, because the alignment in time of the replica of the spreading sequence, a_{DSSS}(j), is determined by the function block “feedback for symbol timing” 820 in the dfTRSS part of the receiver, which is described above. Since the transmitted signals from the bi-directional DSSS transmitter and the uni-directional dfTRSS transmitter have a known timing alignment, the bit timing alignment determined in the dfTRSS receiver path can now be used to align both the starting time of the replica of the spreading code and the bit timing in the DSSS receiver. In some cases of a DSSS radio, where the period of the DSSS spreading sequence is an integer relationship to the dfTRSS symbol period, it may be sufficient to use only the bit edge of the dfTRSS symbol or bit. In other cases, e.g., where a “long code” spreading sequence is used, a unique pattern in the dfTRSS bit stream may further be used to determine the proper time alignment for the DSSS spreading sequence in the DSSS part of the receiver.

Since the uni-directional receiver has a near instantaneous synchronization with the start of the received signal (other than the feedback time to achieve bit sample timing) this can now be used to time align the bi-directional DSSS receiver channel, also nearly instantaneously; the usual search and synchronization time for the DSSS receiver is now greatly diminished in this configuration. For short burst of usage of the bi-directional DSSS radio, this can amount to a large increase in battery life of the mobile terminal.

Secondly, FIG. 8 may be distinguished over a pilot channel in that the timing information is actually coming over a second radio channel 802, which has the unique characteristic that it does not actually synchronize with the spreading code used in that first radio channel 804. The timing alignment is extracted from the bit timing of the first radio channel 804 and used to align the second radio channel 802 through the known relationships of the timing in the two radio transmitters.

Optionally, the frequencies of the two oscillators in the combined receiver can be aligned to bring the oscillators to the correct frequencies quickly. In this added feature, the automatic frequency control (AFC) function in the first radio quickly corrects any error in the local signal Δω₁. If there is an explicit relation between ω_{RF}Δω₂ and Δω₁, this can be utilized to quickly align the local oscillator frequency (ω_{RF}+Δω₂) of the DSSS radio channel and also reduce the search time for the DSSS signal.

Another advantage is that DSSS receiver of the second radio can operate under lower signal-to-noise ratio (SNR) conditions. During acquisition, when frequency and timing is not known yet, the de-spreading is not operational. Therefore, DSSS signal acquisition may operate under very low SNR conditions (frequently below 0 dB). The acquisition time is inversely proportional to the SNR at the receiver input; however, since the first radio, based on dfTRSS, operates at lower data rates and can apply instantaneous de-spreading without acquisition, the first radio can operate under lower SNR conditions. Since the first radio aids the second, DSSS radio in its acquisition process, the second radio can also operate under much lower SNR conditions without requiring an unacceptable acquisition time.

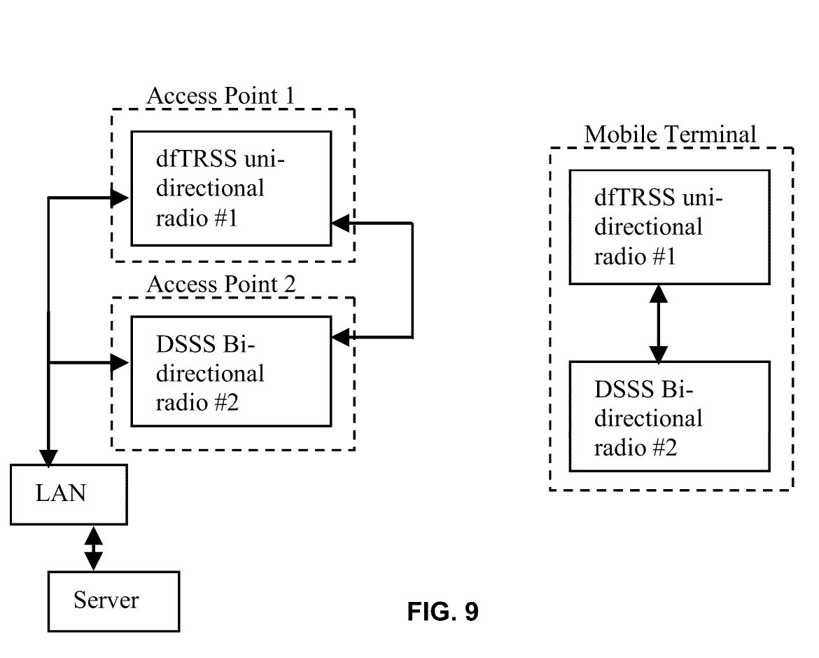

FIG. 9 illustrates another embodiment of a low power TRSS-DSSS hybrid system. FIG. 9 illustrates a first radio channel (uni-directional) 902, 902′ and a second radio channel (bi-directional) 904, 904′ are separate radios but are allowed to share some coordination information in at least the access point and optionally in the mobile device.

An example for this separated environment may be for the first radio system to be a uni-directional dfTRSS access point transmitter and mobile terminal receiver, as previously described, and the second bi-directional DSSS radio system would be a Wideband Code Division Multiple Access (WCDMA) femtocell base station and WCDMA terminal co-located in the mobile terminal with the dfTRSS receiver. In this example, the information 906 shared between the radio systems 902′, 904′ at the access 908 point aligns the first radio bit timing with the second radio bit timing. This can also extend to frame timing to further enhance acquisition speed in the DSSS radio system. Additionally, the information 906 shared can also extend to frequency alignment, possibly via a common oscillator, to also facilitate rapid frequency synchronization in the mobile DSSS radio system. This sharing can occur either via direct connection or be communicated over the LAN connection 920. In the mobile terminal 910, the sharing of the bit timing information 912 from the first radio system 902 to the second radio system 904 accomplishes the same function(s) as described in the section on the combined hardware version, discussed above.

It should be understood that these same techniques of time and frequency alignment via another radio can also be used with other modulation and multiplexing forms besides DSSS, such as second radios using orthogonal frequency-division multiplexing (OFDM) modulation or quadrature amplitude modulation (QAM).

### Low Power Radio Extended Network System

By way of background, bi-directional radio systems are generally based on connections that are established and released, and are controlled by the higher-layer applications. To achieve short latencies, the radio receivers of bi-directional radio systems (e.g., WLAN 802.11, etc.) scan frequently, resulting in high power consumption, or the bi-directional radio systems are locked in low-duty cycle connections (like a sniffed link in Bluetooth). Disclosed below, according to some embodiments, is a low power radio extended network system that has a mobile device with a combined low latency and low power consumption.

As a general overview, a low power radio extended network system (“network system”), as described herein, includes a low-power uni-directional wake-up radio combined with higher power radios to achieve an overall network system that simultaneously achieves both low latency and low power consumption. As part of the network system, support for core applications is included in this disclosure. One such core application may include an indoor positioning system that provides precision indoor location data at low power consumption. The uni-directional radio system can work as auxiliary radio in an indoor system to trigger, at specific locations, a bi-directional radio system to carry out location-dependent operations. When using the uni-directional radio, signals are only broadcast from the uni-directional radio and no internet protocol (IP) connections are established.

The network system described below combines the low power TRSS system (previously described with respect to FIGS. 1-5) with a second bi-directional radio to form an extended network system with useful features for a mobile device yet still maintaining low current consumption in idle mode. The network system includes at least two embodiments: (1) a system where the uni-directional dfTRSS radio is not connected to a network or the bi-directional radio, and only the bi-directional radio is connected to the network; and (2) a system where the uni-directional dfTRSS radio is connected to a network, and is only indirectly connected to the bi-directional radio, which is connected to the network. Other embodiments are clearly with the scope of the present invention. In some embodiments, it should be understood that the radio not being “connected” to the network may refer to the radio as: not having an IP address on the network, not being connected to the server via a cable or a wireless connection, and/or the like.

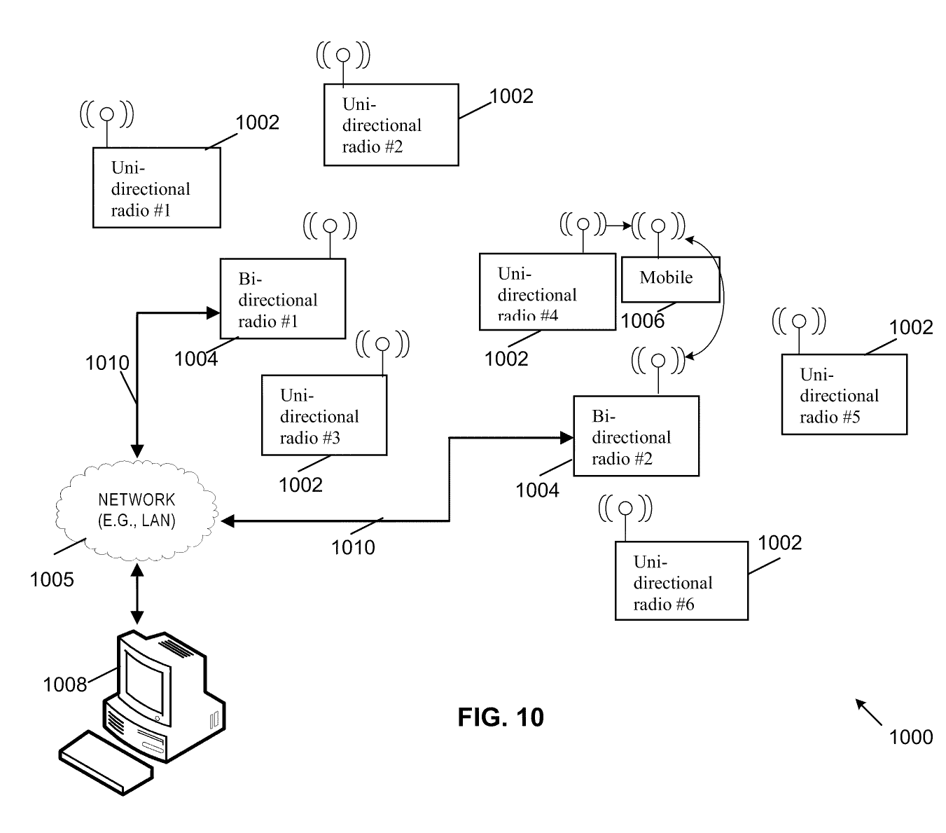

As previously mentioned, FIG. 9 illustrates a first radio channel (uni-directional) 902, 902′ and second radio channel (bi-directional) 904, 904′ that are separate radios but share some coordination information in at least the access point and optionally in the mobile device. This sets up a system that allows for multiple uni-directional channels and multiple bi-directional channels, which minimizes power consumption of the mobile device, as is discussed in more depth below with regard to FIG. 10.

FIG. 10 is a block diagram of an extended network system 1000 in accordance with an embodiment of the present invention. In FIG. 10, multiple first radios (i.e., uni-directional radios) 1002 and second radios (i.e., bi-directional radios) 1004 exist throughout a physical area. The uni-directional radios 1002 illustrated only include a transmitter; the bi-directional radios 1004 illustrated both contain a transmitter (not shown) and a receiver (not shown). As illustrated, there may be more uni-directional radios 1002 than bi-directional radios 1004 and vice versa. There can also be a known association of first radios 1002 to second radios 1002 (in this example, uni-directional radios #1, #2, and #3 are associated with bi-directional radio #1, and further, uni-directional radios #4, #5 and #6 are associated with bi-directional radio #2). The second radios (bi-directional) 1004 are connected to a network 1005, in this case a local area network or LAN. The LAN 1005 is connected to a server 1008 or other computing device. There also exists a mobile device 1006 that contains equipment compatible with the first radios 1002 and second radios 1004. The mobile device 1006, as previously discussed, can be any portable mobile electronic communications device, such as a cellular telephone, a laptop or an electronic watch. In this case, the mobile device 1006 contains a receiver for the uni-directional radio 1002 and a transceiver for the bi-directional radio 1004. Receivers and transceivers are embedded in the mobile device 1006, but are not explicitly illustrated in FIG. 10. Additionally, the transmitters are not illustrated in the uni-directional radios 1002 and the transmitters and receivers are not explicitly illustrated in the bi-directional radios 1004 of FIG. 10.

The first radios 1002 only broadcast data and are thus uni-directional only. The first radios 1002 could, for instance, periodically broadcast a unique ID (which may be similar to a wake-up sequence used in the wake-up radio) and are based on the low-power radio architecture as described above with respect to FIGS. 1-5 and the corresponding description presented therewith. The transmission power is quite low (e.g., below 1 mW) and only a short range is achieved (e.g., a few meters). Because of the restricted range, a plurality of first (uni-directional) radios 1002 would be used for each second (bi-directional) radio 1004 that has a longer range.

The uni-directional low power (“wake-up”) receiver (not shown) in the mobile device 1006, periodically (or continuously) listens. For example, in FIG. 10, the wake up receiver receives a signal from uni-directional radio #4. The first time a mobile device 1006 hears a particular first radio 1002 (which may be determined by a different identification number broadcast), the mobile device 1006 turns on the mobile device's second (bi-directional) radio (not shown) and contacts the nearest second radio system 1004. For example, in FIG. 10, the mobile device's bi-directional radio connects to the network 1005 using bi-directional radio #2, which is an access point. The mobile device 1006 informs the server 1008 of the mobile device's current location or simply that the mobile device 1006 has heard uni-directional radio #4. The mobile device 1006 could do this by sending the uni-directional radio's ID decoded for the uni-directional radio #4 to the server 1008 which then maps this ID to a specific location.

The mobile device 1006 then acts, either immediately or delayed in conjunction with another activity, in a way based on the knowledge that the mobile device 1006 is near uni-directional radio #4. Three examples of this concept is now presented:

In a first example, the server 1008 may have a voice over IP (VoIP) call that it wishes to route to the mobile device 1006. The server 1008 knows to route the data for the VoIP call to the bi-directional radio #2 since the server 1008 knows the location of the mobile device 1006 and which bi-directional radio 1004 was closest in proximity to the mobile device 1004.

By way of another example, the mobile device 1006 may wish to connect to the nearest personal computer (PC) and use the PC's monitor and keyboard. The mobile device 1006 makes such a request over the bi-directional radio 1004 to the server 1008. The server 1008 knows the location of the mobile device 1006 to be near to uni-directional radio #4 and routes the request (and subsequent data) to the PC (not shown in FIG. 10) nearest uni-directional radio #4.

By way of a third example, an incoming voice call to the user of the mobile device 1006 can be routed to a desk/landline phone (not shown in FIG. 10) nearest uni-directional radio #4.

In any event, the above-described communications network system includes a second radio 1004 that is used as the data communication link when used in conjunction with operation of the first radio system 1002 to determine location of the mobile device 1006.

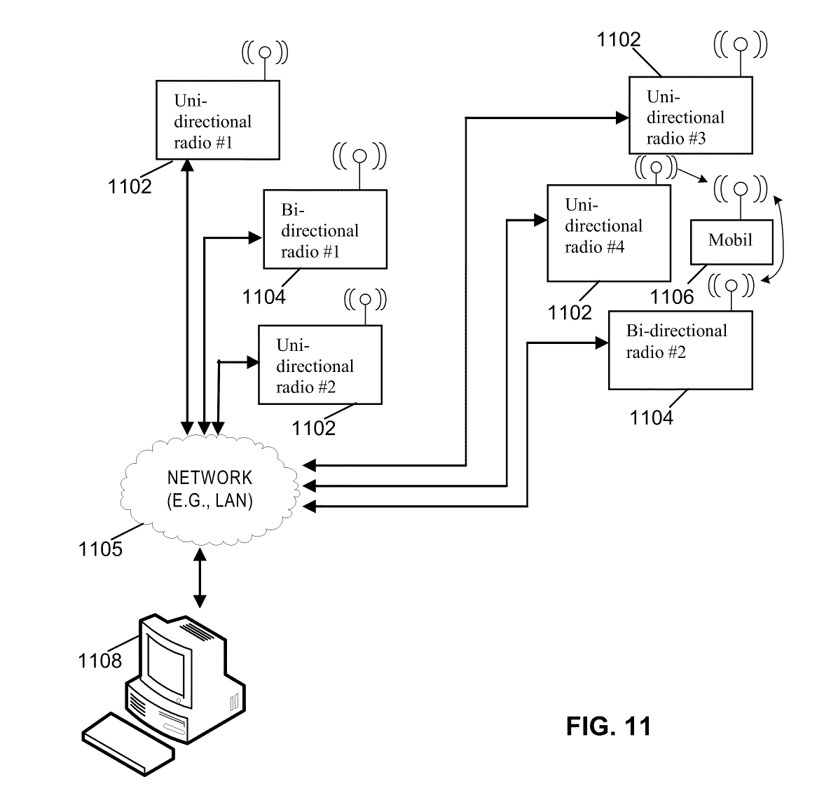

FIG. 11 shows an exemplary system 1100 to include IP connectivity of a server 1108 via the LAN 1105 to some or all of the uni-directional radios 1102 in the network system 1100. There also exists IP connectivity of the server 1108 via the LAN 1105 to all the bi-directional radio access points 1104. Multiple first radios (uni-directional) 1102 and second radios (bi-directional) 1104 exist throughout a physical area. There can be more uni-directional radios 1102 relative to the bi-directional radios 1104 and vice versa. There can also be a known association of first radios 1102 to second radios 1104. For example, in FIG. 11, uni-directional radio transmitters #1 and #2 are associated with bi-directional radio access point #1, and further, uni-directional radio transmitters #3 and #4 are associated with bi-directional radio access point #2. The LAN 1105 is connected to a server 1108. There also exists a mobile device 1106 that contains equipment compatible with the first radios 1102 and second radios 1104. In this case, the mobile device 1106 contains a receiver for the uni-directional radio 1102 and a transceiver for the bi-directional radio 1104.

The mobile device 1106 listens to the collection of uni-directional radios 1102 that make up a uni-directional radio system and the mobile device 1106 determines the uni-directional radio 1102 nearest to the mobile device 1106, such as by detecting the strongest wireless signal or by any other means. As illustrated in FIG. 10, the mobile device 1106 determined that uni-directional radio #4 is the nearest uni-directional radio 1102. In response to determining the nearest uni-directional radio 1102, the mobile device 1106 turns on the mobile device's bi-directional radio (not shown) and contacts the nearest bi-directional radio (e.g., bi-directional #2 of FIG. 10) and notifies the server 1108 of the mobile device's location nearest uni-directional radio (i.e., uni-directional radio #4 in the example of FIG. 10). The mobile device's bi-directional radio is then turned off and, thus saving current and power consumption at the mobile device 1106. Now, whenever the server 1108 wishes to connect to the mobile device 1106, the server 1108 can send messages or data directly to the mobile device 1106 via the nearest uni-directional radio 1102 (e.g., uni-directional radio #4) or the server 1108 can direct the mobile device 1106 (via a message delivered from the nearest uni-directional radio #4) to turn on the bi-directional radio 1104 and start an IP connection with bi-directional radio (i.e., bi-directional radio #2).

In this method, the uni-directional radio 1102 that serves as a positioning unit can then also operate as wake-up radio. The following procedure describes combining low latency with low power. If the network system server wants to connect to the mobile device 1106 via a WLAN access point, the network system will use the positioning unit (the low-power, uni-directional radio 1102) as an intermediary. The mobile device 1106 will continuously listen to the positioning radio signals from the uni-directional radios 1102 since the power consumption on this interface is very low. The server 1108 knows on which uni-directional radio 1102 or other location the phone is camped since that was the last positioning ID reported by the mobile device 1106 to the server 1108. If the server 1108 wants to connect to the mobile device 1106, the server 1108 sends an instruction via the IP connection to the appropriate uni-directional radio 1102 (i.e., #4 in this example of FIG. 10) which passes that instruction to the mobile device 1106 over an interface of the first radio (uni-directional) radio 1102. This can be done with a wake-up sequence unique to the mobile device 1106. Once the second radio (bi-directional) 1104 in the mobile device 1106 is activated, a connection between the server 1108 and the mobile device 1106 can be established.

The above discussion related to the section labeled “Low Power TRSS-DSSS Hybrid System” discloses how the information from the first radio 1102 can be used to enable a faster connection between the mobile device 1106 and the access point of the second radio system 1104. This additional method can be incorporated into the low power radio extended network system 1100 immediately described above to enable a fast connection to the second radio 1104. The method of the hybrid TRSS-DSSS system might include such information as frequency, relative timing alignment as previously discussed. However, additional information not related to rapid frequency and timing acquisition might also be sent via the first radio system 1102, such as an encryption key to allow access to the second radio 1104, or an identification sequence required to look for prior to connecting to the correct second radio access point.

By continuously monitoring the positioning IDs on the low-power radio interface, the mobile device 1106 can determine whether it has changed position. If the mobile device 1106 has changed positions or locations, the mobile device 1106 will inform the server 1108 of the new cell or location the mobile device 1106 is camped in, such as by sending the positioning ID of the new cell or location. The procedure described above allows for very low-power IP connections—the IP connection is allowed to remain active, but the physical connection is only established for a short while when the IP packets need to be exchanged.

It should be noted that the uni-directional radios in the network system can be devices that can simply be plugged into an AC mains power outlet and be wireless. This allows the uni-directional radios to be easily portable and moveable. Additionally, the uni-directional radios may connect to a network using any network, such as a network resident on electrical wires. For example, an ethernet LAN network can be established using existing electrical wiring and mains power outlets of a building. Accordingly, the uni-directional radio units, bi-directional radio units and a server can be plugged into a mains power outlets to form a LAN network. This allows the uni-directional radios and bi-directional radios communicate to not only be powered by power outlets but also simultaneously allows for the uni-directional and bi-directional units to communicate over the same existing electrical power outlets and wiring of a building.

The Figures illustrate the architecture, functionality, and operation of possible implementations of systems and methods according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by a human or special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A radio system comprising:
a server connected to a network;
at least one bi-directional radio connected to the network; and
at least one uni-directional radio not connected to the at least one bi-directional radio and not connected to the server,
wherein a mobile device is configured to receive data from the at least one uni-directional radio and communicate with the at least one bi-directional radio.

2. The radio system of claim 1, wherein the mobile device is configured to receive data from a uni-directional radio of the at least one uni-directional radio where the uni-directional radio is closest in proximity to the mobile device relative to other uni-directional radios of the at least one uni-directional radio.

3. The radio system of claim 1, wherein the mobile device receives identification information from the at least one uni-directional radio, the identification information comprising information to notify the server of the location of the mobile device.

4. The radio system of claim 3, wherein the mobile device transmits the identification information to the at least one bi-directional radio, the at least one bi-directional radio communicating the identification information to the server.

5. The radio system of claim 1, wherein the at least one bi-directional radio has an IP address on the network.

6. The radio system of claim 1, wherein the bi-directional radio is configured to transmit and receive data and wherein the at least one uni-directional radio is configured to only transmit data and not receive data.

7. The radio system of claim 1, wherein the at least one uni-directional radio comprises a plurality of uni-directional radios, and wherein the at least one bi-directional radio comprises a plurality of bi-directional radios:

8. A radio system comprising:
a server connected to a network;
a bi-directional radio connected to the server; and
a uni-directional radio connected to the server,
wherein a mobile device is configured to receive data from the uni-directional radio and communicate with the bi-directional radio.

9. The radio system of claim 8, wherein the bi-directional radio has an IP address on the network.

10. The radio system of claim 8, wherein the uni-directional radio has an IP address on the network.

11. The radio system of claim 8, wherein the uni-directional radio transmits identification information to the mobile device.

12. The radio system of claim 11, wherein the identification information comprises positional information.

13. The radio system of claim 8, wherein the mobile device determines if the uni-directional radio is closest to the mobile device.

14. The radio system of claim 8, wherein the mobile device transmits information to the bi-directional radio.

15. A mobile device comprising:
a receiver configured to receive data from a bi-directional radio connected to the server and a uni-directional radio, wherein the bi-directional radio is connected to a server via a network; and
a transmitter configured to communicate with the bi-directional radio.

16. The mobile device of claim 15, wherein the uni-directional radio is not connected to the network and is not connected to the bi-directional radio.

17. The mobile device of claim 15, wherein the uni-directional radio is connected to the network but is not connected to the bi-directional radio.

18. The mobile device of claim 15, wherein the receiver receives a signal from the uni-directional radio and determines if the uni-directional radio is proximate to the mobile device.

19. The mobile device of claim 15, wherein the transmitter transmits information received from the un-directional radio.

20. The mobile device of claim 15, wherein the uni-directional radio is configured to only transmit data and the bi-directional radio is configured to transmit and receive data.
